(19) United States
(12) Patent Application Publication
(10) Pub. No.: US 2025/0086015 A1
(43) Pub. Date: Mar. 13, 2025

(54) APPARATUS AND A METHOD AND A NON-TRANSITORY MACHINE-READABLE STORAGE MEDIUM

(71) Applicants: Antonio VALLES, Mesa, AZ (US); Rebecca DAVID, Santa Clara, CA (US)

(72) Inventors: Antonio VALLES, Mesa, AZ (US); Rebecca DAVID, Santa Clara, CA (US)

(21) Appl. No.: 18/890,806

(22) Filed: Sep. 20, 2024

(30) Foreign Application Priority Data
Sep. 20, 2023 (US) 63/583883

(51) Int. Cl. G06F 9/50

(52) U.S. Cl. CPC G06F 9/5027

(57) ABSTRACT

It is provided an apparatus comprising interface circuitry, machine-readable instructions, and processing circuitry to execute the machine-readable instructions. The machine-readable instructions include instructions to: obtain execution phases of an application; to determine critical execution phases among the obtained execution phases based on one or more execution-performance metrics of the execution phases; to cluster execution tasks performed in the determined critical execution phases into one or more clusters corresponding to the respective execution phase based on a runtime behavior of the respective execution tasks; and to generate a performance model based on the determined clusters. The execution phases are designated during a first execution of the application. The execution of the application comprising a plurality of parallel-executing processes distributed on a single node or across a plurality of nodes. The execution phases are determined based on communication events among at least a part of the plurality of processes.

### BACKGROUND

In High-Performance Computing (HPC), applications are designed to solve complex, large-scale problems by distributing computational tasks for example across multiple nodes, processors, and/or processing cores in parallel. These applications are important in fields such as scientific research, engineering, and data analysis, where the ability to process vast amounts of data quickly is important. Optimizing the performance of such application in HPC may be challenging due to the intricate nature of communication and computation among distributed processes. For example, as the distributed systems scale, identifying and addressing bottlenecks, inefficiencies, and resource management issues may be become important to improve overall performance.

### BRIEF DESCRIPTION OF THE FIGURES

Some examples of apparatuses and/or methods will be described in the following by way of example only, and with reference to the accompanying figures, in which

FIG. 1 illustrates a block diagram of an example of an apparatus;

FIG. 2 illustrates a flowchart of an example of a method;

FIG. 3 illustrates an MPI (Message Passing Interface) phase of an HPC application that utilizes MPI;

FIG. 4 illustrates an HPC application broken up into MPI phases;

FIG. 5 illustrates a first measurement and a second measurement of runtimes of MPI phases of an HPC application;

FIG. 6 illustrates the clustering of three MPI phases based on runtime behavior;

FIG. 7 illustrates a figure of merit (FOM) of the HPC application comprising a plurality of MPI phases;

FIG. 8 illustrates a tabular view of the FOM of FIG. 7;

FIG. 9 illustrates flowchart of an example of a method to generate the application performance model;

FIG. 10 illustrates a flowchart of an example of a method to generate the application performance model based on the determined clusters from the MPI phases;

FIG. 11 illustrates a table showing performance impact of applying the lightweight data acquisition to generate the application performance model; and

FIG. 12 illustrates a graph showing possible performance optimizations based on the generated application performance model.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

In High Performance Computing (HPC) applications may be used in super computers or large clusters to solve or simulate real world problems such as molecular dynamics, weather/climate models, oil and gas explorations, and for national defense purposes. Properly analyzing these applications may be critical to identify bottlenecks and improve performance at the single node level and at the multi-nodelevel. However, these applications may sometimes be too large (in number of nodes used, number of source files/functions employed, and in application run-time duration) and complex (especially the added communication) to apply conventional profiling techniques that work for desktop applications. There may be for several reasons: First, common profiling techniques consider the entire runtime of the application storing large amounts of data and are thus unable to scale to these large applications. Second, data collected and provided is too detailed to give the user meaningful insights and/or an overall understanding of the application. Third, the findings from detailed data gathered during the duration of the application may be invalid due to the high profiling overhead incurred.

Previous techniques to this problem include using an end-to-end (E2E) application profiler (for example NVIDIA® Nsight system, Intel® Application Performance Snapshot (APS), Intel® VTune etc.). Other previous techniques include using a CPU-only profiler (e.g., Linux Perf, Tuning and Analysis Utilities (TAU)) or GPU-only profilers (e.g., NVIDIA® Nsight compute) or MPI-only profilers (e.g., Intel® Trace Analyzer and Collector (ITAC)). However, these previous techniques may fail due to having to store large amounts of data during entire runtime of the application and/or being invalid due to the high profiling overhead. That is, many of the above mentioned tools may fail or may become too intrusive once the HPC application starts running large number of nodes and/or the runtime is too large due to the amount of data that needs to be stored. Further, the previous techniques may fail because they are too detailed to give the user meaningful insights. That is, HPC applications may have a large startup (possibly warmup as well) and shutdown regions that do not contribute to the measured performance of the application (i.e. not part of the Figure of Merit (FOM) region). The above mentioned tools cannot distinguish which functions contribute to the FOM and which do not. This may be troublesome when the same functions are used in the warm-up regions as in the FOM regions impacting the overall profile.

The proposed art addresses these concerns using a novel combination of phase detection and runtime behavior patterns to limit the amount of data collected and to focus the analysis on significant repeating portions.

The proposed technique enables the ability to describe an application's behavior and facilitate targeted analysis and optimizations. The proposed technique may interpose Message Passing Interface (MPI) API calls (or other communication protocols), designates phases (such as MPI phases), and capture workload and/or application data while multi-node/multi-card HPC application executes. For example, some HPC applications may use process-to-process communication calls like MPI APIs, Partitioned Global Address Space (PGAS) APIs or the like. These APIs may be important because they may enable the HPC applications to scale from one node to many nodes. Some API calls may be used to group portions of the application into phases (for example MPI phases). The proposed technique may use post-processing to identify significant phases, use run behavior to group each important phase into clusters, and use these clusters and their occurrences to create the application performance model that may be utilized to describe the performance of the application, to understand the application, and for targeted analysis. For example, the constructed application performance model may then be used to target performance analysis and optimizations of the application and/or specific portions of the application.

The proposed technique may be used by customers who are invested in large computing clusters targeted to solve important problems for national defense, public health, weather, space research etc. The proposed technique may greatly benefit users due to cost savings due to the performance optimizations enabled by its analysis. These cost savings may include but are not limited to the following: increased performance and time to solution, power savings, productivity (minimal user involvement and expertise needed), and increased competitiveness for customer deals.

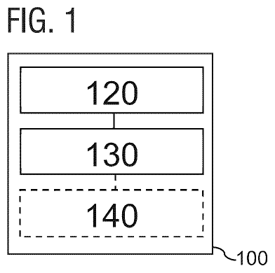

FIG. 1 illustrates a block diagram of an example of an apparatus 100 or device 100. The apparatus 100 comprises circuitry that is configured to provide the functionality of the apparatus 100. For example, the apparatus 100 of FIG. 1 comprises interface circuitry 120, processing circuitry 130 and (optional) storage circuitry 140. For example, the processing circuitry 130 may be coupled with the interface circuitry 120 and optionally with the storage circuitry 140.

For example, the processing circuitry 130 may be configured to provide the functionality of the apparatus 100, in conjunction with the interface circuitry 120. For example, the interface circuitry 120 is configured to exchange information, e.g., with other components inside or outside the apparatus 100 and the storage circuitry 140. Likewise, the device 100 may comprise means that is/are configured to provide the functionality of the device 100.

The components of the device 100 are defined as component means, which may correspond to, or implemented by, the respective structural components of the apparatus 100. For example, the device 100 of FIG. 1 comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

For example, the storage circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The processing circuitry 130 is configured to obtain execution phases of an application. The execution phases are designated during a first execution of the application. In some examples, the designated phases are determined in a post-processing from collected workload data (see below). The execution of the application comprises a plurality of parallel-executing processes on a single node or distributed across a plurality of nodes. The execution phases are determined based on communication events among at least a part of the plurality of processes. In some examples, the execution phases are determined based on a combination of communication events and an execution-performance metric of the execution phases (such as call stacks of the communication events etc. see below).

A node may be a physical computing system (such as a server), and each node may contain multiple processor and GPU cores. A process may represent an independent sequence of execution within the application, while a rank refers to the unique identifier assigned to each process in a distributed computing environment, such as one using the MPI API. These processes can communicate and work together across multiple nodes to complete large-scale tasks. For example, the application may be an HPC (High-Performance Computing) application. An HPC application is a software program designed to solve complex, large-scale problems by distributing computational tasks across multiple nodes and processors, often in parallel.

Execution phases of the application (for example an HPC application) are representing unique repeating behavior. Further, execution phases of the application may be segments of the application's runtime, defined by significant communication events between the processes. In the context of HPC applications, the execution of tasks is distributed across multiple processes running on different nodes. These processes frequently need to synchronize or exchange data to complete the overall computation. Execution phases are defined as segments of the application's runtime where certain key actions happen, particularly related to the communication between these processes. The key communication points, such as when processes share data or synchronize, mark the boundaries of these phases. In this way, each phase represents a period of time where processes perform calculations or tasks between communication events, which are crucial for coordinating work among distributed nodes.

The same execution phase may occur multiple times if the application repeatedly executes the same block of code, particularly in iterative processes or loops. Each time the execution phase may begin and end with the same pair of collective calls and their call-stacks and/or other runtime behavior, it may be recognized as a repetition of that phase. If an execution phase occurs several times, the occurrences may be referred to as instances of the execution phase. To systematically track these repetitions, each execution phase may be assigned a unique identifier (e.g., phase 1020), which stays consistent across instances, whether they occur sequentially or in parallel across different ranks. For example, interposition methods that capture the MPI API calls, GPU driver calls, and possibly even profilers for CPU calls can all capture key metrics such as execution time, resource utilization, call stacks, or communication overhead—allowing for the identification of repeated instances of the same execution phase. By analyzing the structure of collective calls, the behavior of code between them, and the performance data associated with each occurrence, one can determine how often and where the same execution phase is repeated during the application's run.

In some examples, the processing circuitry is configured to capture workload and/or application data (application runtime data and/or behavior for the specific workload and input parameters executed by application) during the execution phases of the first and/or second execution of the application. The processing circuitry 230 may be further configured to determine the runtime behavior of the respective execution tasks based on the captured workload data. That is, in the first execution of the application, minimal workload data is captured to avoid impacting the application's performance. This is achieved through lightweight instrumentation, which collects only the essential data needed to determine the execution phases without adding significant overhead. The workload data from this first execution is used to determine the runtime behavior of the application, such as identifying key execution phases, resource consumption patterns, and communication events among the processes. In a second execution of the application (see below), more detailed workload data is captured, allowing the processing circuitry 230 to determine specific runtime performance metrics for specific instances of some execution phases.

The execution phases may be determined by the processing circuitry 130. For instance, the processing circuitry 230 may monitor the application's communication events during the first execution of the application and determine when one phase ends and the next begins. In some example the execution phase may be determined by an external device and may be obtained by processing circuitry 230 for example via the interface circuitry 120. For example, the external device may a performance monitoring system. For example, the external monitoring device may analyze the runtime behavior and transmit the information about execution phases to the processing circuitry, which can then process or optimize the application accordingly. This enables dynamic identification and handling of critical phases during the application's runtime, improving overall efficiency and performance.

In some examples, an execution phase is starting at the end of a first communication event and ending at the end of the consecutive communication event and the communication events call-stacks and/or other runtime behavior. This describes how execution phases are delimited. Specifically, a phase begins after a process completes its participation in one communication event (e.g., broadcasting data), and ends after it participates in the next communication event (e.g., gathering data from other nodes). Adding, additional runtime data like call-stack information of the communication events into the phase definition provides a means to distinguish between the same communication calls. This creates a well-defined beginning and end for each execution phase, allowing for the isolation of computational tasks happening between these communication points. Each phase, therefore, may consist of the time and work between two consecutive communication events, ensuring the boundaries are clearly marked by these events.

In some examples, the execution phases are determined based on Messaging Passing Interface (MPI) communication events among the plurality of processes. The Message Passing Interface (MPI) is a widely-used standard in HPC applications for enabling processes to communicate with each other, particularly in distributed computing environments. MPI defines a set of communication protocols (or events) that allow processes to exchange data or synchronize. In this case, MPI communication events such as broadcasting, reducing, or gathering are used to determine the start and end points of an execution phase. Since MPI events are the central mechanism for inter-process communication in many HPC applications, they are a natural choice for marking the boundaries of execution phases, providing a framework to understand and manage the workflow.

In some examples, an execution phase is starting at the end of a MPI collective communication event and is ending at the end of the consecutive MPI collective communication event. For example, the period between two collective communication events (where processes synchronize or exchange data) forms an execution phase. An MPI collective communication event is a special type of MPI event where all processes in a group must participate. Examples include MPI_Bcast (broadcasting data to all processes) or MPI_Reduce (aggregating data across all processes). In this approach, the start of an execution phase is triggered once a process finishes a collective communication event, and the phase continues until the next collective communication event finishes. Between these events, processes are engaged in their own local work, such as calculations, before synchronizing or exchanging data with other processes at the next collective communication event. This method of defining phases allows for a clear understanding of the tasks being done in isolation and the tasks that involve inter-process coordination.

In some examples, the execution phases are determined based on two consecutive communication events among the plurality of processes. In some examples, the execution phases are determined based on two non-consecutive communication events among the plurality of processes. Typically, execution phases are marked by consecutive communication events, where the start of the phase is triggered by one event, and the phase ends with the next. However, in some cases, it is possible that execution phases are determined by non-consecutive communication events, meaning the phase may span a longer period, skipping intermediate communication events. For example, a phase could begin at the end of one collective event and end several communication events later, depending on how the application defines the phase boundaries. The flexibility in using either consecutive or non-consecutive events allows for more complex segmentation of the application's runtime, especially in applications where different sets of processes communicate at different times.

In some examples, the MPI collective communication event is at least one of the following: broadcasting, reducing, all-reducing, synchronizing, and gathering. MPI collective communication events involve coordinated actions across all processes in the application, and each of these types of events serves a specific purpose in data exchange or synchronization. Examples include: broadcasting (MPI_Bcast) where one process sends data to all other processes; reducing (MPI_Reduce) where all processes send their data to a root process which performs an operation (e.g., summing values) and then shares the result; all-reducing (MPI_Allreduce), similar to reducing, but where the result is sent back to all processes, not just the root; synchronizing (MPI_Barrier), where all processes reach a synchronization point and wait until all have caught up; and gathering (MPI_Gather), where all processes send data to one designated process. These events serve as key points for defining execution phases because they require all processes to participate, making them natural boundaries for phase segmentation. The application can define its execution phases based on any of these collective events, depending on which actions are critical to the parallel workflow.

The processing circuitry 130 is configured to determine critical execution phases among the obtained execution phases based on one or more execution-performance metrics of the execution phases. In some examples, the one or more execution performance metrics comprise at least one of the following: resource utilization, communication overhead, critical computational tasks, I/O intensity, thread utilization, hardware events, number or names of GPU or CPU or driver function calls, and call stack behavior.

In some examples, the processing circuitry 130 may determine the critical execution phases among the obtained execution phases based the FOM of the application. For example, the on one or more execution-performance metrics of the execution phases may determine the FOM. In other words, all execution phases that may not be part of a figure of merit (FOM) of the application, may be removed from the pool of execution phases that may be considered as critical execution phases.

Applications time and report FOM performance. Thus, significant or critical phases are phases that are part of the FOM. The new technique iterates until it finds the critical phases that make up all/most of the FOM time. Resource utilization, types of communication calls, and other performance metrics previously discussed can be used to help determine the critical phases that make up the FOM. And just as important the phases that can be filtered out as not being part of the FOM.

Resource utilization may refer to how efficiently a phase uses the available hardware resources, such as CPU, GPU, memory, and storage. In HPC applications, high CPU or GPU utilization indicates that processors or devices are fully engaged in complex computations, while high memory usage suggests large datasets are being processed.

In some examples, for example, if FOM may be not available, a phase may be marked as critical if it exceeds a specific threshold, such as CPU utilization above 85% or memory usage above 90% of capacity. Profiling tools that monitor real-time resource consumption can be used to identify phases that significantly strain system resources. In some examples, critical computational tasks may refer to those essential to the core functionality of the application, such as solving mathematical equations, performing matrix operations, or executing iterative algorithms. These tasks typically require substantial processing time and resources, and often represent the performance bottlenecks in HPC applications. For example, a phase involving matrix factorization or solving a system of linear equations may dominate the overall runtime. A phase may be marked as critical if computational tasks within it consume more than 60% of the total runtime. Performance tools that monitor high floating-point operations (FLOPs) or similar metrics can help identify these phases.

In some examples, I/O intensity may refer to the amount of data read from or written to storage during a phase. Phases that involve significant I/O operations, such as writing checkpoints or reading large input files, can become bottlenecks if the storage system or network is slow. In data-intensive applications, phases dominated by I/O operations may be particularly critical if they delay other computational tasks. A phase can be deemed critical if I/O time exceeds 30% of the total runtime, or if more than 10 GB of data is transferred during its execution. File I/O monitoring tools are used to track and measure the intensity of these operations.

In some examples, thread utilization may refer to how effectively an application leverages the available threads on a system. In multi-threaded environments, each thread represents a unit of work, and high thread utilization indicates that most or all threads are actively performing tasks. Poor thread utilization, on the other hand, may suggest underutilization of processing resources, where some threads are idle or waiting on tasks to complete. In HPC applications, thread utilization is critical for maximizing parallelism. A phase may be considered critical if it underutilizes threads, especially in cases where utilization falls below a certain threshold, such as less than 70% of available threads being active.

In some examples, hardware events may be low-level operations performed by the CPU or other hardware components, such as cache misses, branch mispredictions, memory accesses, or instructions retired (completed). These events provide insight into how efficiently the hardware is executing the application. For instance, a high number of cache misses can indicate inefficient memory access patterns, while frequent branch mispredictions can point to suboptimal control flow. A phase can be marked critical if specific hardware events, like cache misses or memory stalls, exceed a predefined threshold, such as more than 10,000 cache misses per second. Profiling tools that monitor hardware performance counters help in identifying phases where hardware inefficiencies are prominent.

In some examples, call stack behavior may refer to the sequence of function calls made during an application's execution. Understanding the call stack is essential for identifying which functions or methods are contributing most to the overall runtime. Certain phases may be considered critical if they involve deep or recursive call stacks, which can introduce overhead. Profiling the call stack can reveal performance bottlenecks, such as functions being called repeatedly in an inefficient manner. A phase might be flagged if a small number of functions are responsible for a disproportionately high amount of time spent, or if functions are called with high recursion or stack depth.

In some examples, combining all these metrics may provide a comprehensive view of the criticality of an execution phase. Each metric offers unique insights into different aspects of performance, and they can be weighted based on the specific application needs. For example, an HPC application with high communication demands might prioritize communication overhead, while a computation-heavy application would weigh critical computational tasks more heavily. A phase can be marked as critical if it exceeds a threshold in one or more of these metrics, or if a combination of lower-weighted metrics together cross an overall criticality threshold. Using a scoring system allows for a nuanced ranking of phases, where those exhibiting significant issues in multiple metrics are prioritized for optimization.

For example, all execution phases that may not be part of a figure of merit (FOM) of the application, may be removed from the pool of execution phases that may be considered as critical execution phases.

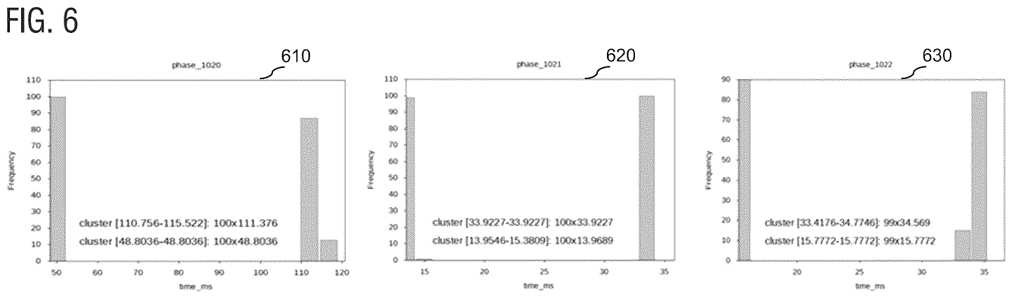

The processing circuitry 130 is configured cluster execution tasks performed in the determined critical execution phases into one or more clusters corresponding to the respective execution phase based on a runtime behavior of the respective execution tasks. In some examples, the runtime behavior of a respective execution task may comprise at least one of a: duration of the respective execution task, retired instructions of the respective execution task, hardware events of the respective execution task. To cluster execution tasks performed in the determined critical execution phases, the runtime behavior data of each task such as task duration, retired instructions, and hardware events—is collected and analyzed. One method to cluster is using a histogram as shown in FIG. 6 where the x-axis is the runtime behavior (e.g. time) and the y-axis is frequency (i.e. number of occurrences). If a combination of behaviors is required, tasks with similar runtime behaviors can be grouped into clusters using a clustering algorithm like k-means. For example, tasks with long durations and high numbers of retired instructions may be grouped into one cluster, while tasks with frequent cache misses and short durations may form another. This clustering allows the system to identify groups of tasks that share common performance characteristics, making it easier to analyze and optimize phases. Once the clusters are formed, the system can select a representative task from each cluster to focus more detailed performance analysis on a smaller, more manageable subset of tasks, helping streamline the overall optimization process. In some examples, the clusters may comprise execution task of an execution phase that occurs only once (one instance). In another example, the clusters may comprise executions tasks of execution phases that have several occurrences.

Duration of the respective execution task in either CPU or GPU may refer to the amount of time it takes for an execution task to complete within a specific phase. The duration is a key metric for understanding how long individual tasks run, which helps in identifying tasks that may be taking too long or contributing to overall performance bottlenecks. A longer task duration could indicate inefficiencies or issues with resource allocation, while shorter durations may point to tasks that are more efficient. Tracking the duration of each task allows for precise performance optimization.

Retired instructions of the respective execution task may refer to the total number of CPU instructions that were successfully executed and completed (retired) by the processor for a specific task. Retired instructions provide insight into how efficiently the CPU is executing tasks. A higher number of retired instructions may indicate that a task is computation-heavy, while a lower number could suggest that the task is waiting on resources or facing delays due to memory or I/O issues. Monitoring retired instructions can help identify phases where tasks are heavily utilizing the processor.

Hardware events of the respective execution task may refer to low-level operations performed by the CPU, GPU, or other hardware components during the execution of a task. Examples of hardware events include cache misses, branch mispredictions, memory accesses, and processor stalls. These events provide detailed insights into the hardware's behavior while executing tasks, allowing for the identification of inefficiencies in data access, control flow, or memory usage. For example, a high number of cache misses could indicate poor memory access patterns, whereas frequent branch mispredictions might suggest suboptimal code execution paths.

The processing circuitry 130 is configured to generate a performance model based on the determined clusters. In other words, the generated performance model may represent a structured overview of the application's runtime behavior during its critical execution phases. This model may be composed of the clusters, where each cluster groups execution tasks that exhibit similar performance characteristics. The performance model, therefore, may provide a consolidated view of the application's execution, highlighting areas where tasks share similar performance traits, and it allows the system to focus on optimizing these representative tasks.

This described technique of dividing an application into phases allows for a detailed analysis of the runtime behavior and performance bottlenecks of the application. Determining these phases is crucial for performance analysis, as it helps identify critical tasks and areas where optimization is needed. Further, the proposed technique may be used by customers who are invested in large computing clusters targeted to solve important problems for national defense, public health, weather, space research etc. The proposed technique may greatly benefit due to cost savings due to the performance optimizations enabled by its analysis. These cost savings may include but are not limited to the following: increased performance and time to solution, power savings, productivity (minimal user involvement and expertise needed), and increased competitiveness for customer deals.

In some examples, processing circuitry 230 is further configured to analyze an execution of the application based on the generated performance model. The analysis may comprise determining how the application's execution behaves relative to a pre-determined performance ceiling (referred to as roofline) and/or hardware limits, such as memory bandwidth and compute intensity, using insights provided by the clusters. This may comprise to identify key performance limitations that can be addressed by improving the efficiency of specific execution tasks or phases. For example, the analysis may comprise examining the clusters of tasks of the generated performance model identified in the performance model and determining their position relative to performance constraints such as the roofline model. For instance, if a cluster of tasks generated performance model is limited by memory bandwidth, the system may flag this cluster as memory-bound, indicating that improving memory access patterns could yield performance improvements. Alternatively, a cluster generated performance model may be compute-bound, meaning the tasks are utilizing the available computation resources but are not reaching optimal performance due to inefficiencies. By identifying where clusters generated performance model fall in terms of memory vs. compute balance, the analysis highlights which parts of the application are constrained by hardware limits and where optimizations could yield the most benefit.

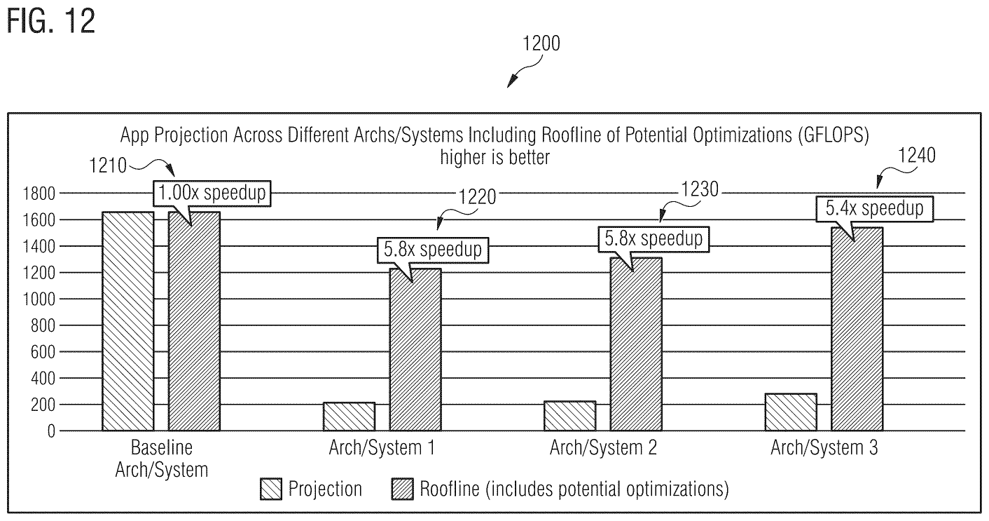

In some examples, processing circuitry 230 is further configured to optimize an execution of the application based on the generated performance model. The optimization may comprise using insights from the generated performance model to improve the execution of the application by targeting specific clusters identified during the analysis. The optimization may further comprise adjusting the execution of tasks or phases that are constrained by hardware limits or performance ceilings (e.g., memory bandwidth or compute intensity) to bring them closer to optimal performance. The optimization may aim to address the key performance limitations that were identified during the analysis phase, with a focus on improving the efficiency of execution tasks or phases that fall short of their potential due to hardware or resource bottlenecks. For example, the optimization may comprise adjusting the execution of tasks within clusters identified as memory-bound by improving memory access patterns, such as reordering data accesses, optimizing cache usage, or reducing memory stalls. This ensures that memory-bound clusters utilize available memory bandwidth more efficiently. For example, for clusters identified as compute-bound, the system may optimize computational efficiency by enhancing parallelization, vectorization, or improving load balancing across processing units. For example, the optimization may comprise refining communication patterns within the distributed application, such as modifying MPI synchronization points or improving data distribution methods, to ensure that communication-bound clusters are better aligned with the performance ceilings of the hardware. The optimization may be driven by insights from the performance model and is aimed at reducing bottlenecks and maximizing resource utilization for critical clusters (see also FIG. 12 below)

In some examples, the clustering of execution tasks is performed by a clustering algorithm that groups the tasks into a number of clusters for each of the critical execution phases. For example, algorithms used for this purpose include k-means clustering, which partitions tasks into clusters based on the similarity of their runtime behavior, and hierarchical clustering, which creates a hierarchy of nested clusters. Another approach could be DBSCAN (Density-Based Spatial Clustering of Applications with Noise), which forms clusters based on the density of task points in the runtime behavior space, making it useful for identifying clusters of tasks with varying densities, such as phases that include both long-running and short-running tasks. For example, tasks that consistently take longer to complete or show similar patterns of hardware events like cache misses may be grouped into one cluster, while shorter tasks with fewer hardware events might form another cluster. The number of clusters can be either pre-determined or dynamically adjusted based on the variability in the runtime behavior of the tasks. For example, in an execution phase with a diverse range of task behaviors (e.g., some tasks being highly CPU-intensive while others are communication-bound), the system may use a higher number of clusters to capture the different patterns. In a more uniform phase, fewer clusters may suffice. Clustering allows for a structured approach to organizing tasks by their behavior, making it easier to analyze the performance of specific groups and identify optimization opportunities.

In some examples, the processing circuitry 230 may be further configured to determine a cluster average for each of the determined clusters with regards to the runtime behavior used for clustering. For example, if tasks are clustered based on their execution duration and retired instructions, the cluster average will reflect the average time taken and average number of instructions retired for that group of tasks. Suppose one cluster contains tasks that take an average of 100 milliseconds to complete and retire 1.5 million instructions. This average serves as a baseline to understand the typical behavior of tasks within that cluster and helps in detecting anomalies—tasks that deviate significantly from this average might indicate inefficiencies or potential issues. By computing these averages, the system can summarize the performance charact

In some examples, the processing circuitry 230 may be further configured to determine a representative execution task for each of the determined clusters. The representative execution task may be the respective execution task that is closest to the respective determined cluster average. In some examples, the clusters may comprise execution task of an execution phase that occurs only once (one instance). In another example, the clusters may comprise executions tasks of execution phases that have several occurrences. For example, determining a representative execution task may comprise or may be equivalent to determining a specific instance of the execution phase. The representative execution task may be the one whose runtime behavior is closest to the cluster average, making it a typical example of that cluster's behavior. For instance, in a cluster where most tasks complete in around 100 milliseconds and retire about 1.5 million instructions, the representative task would be one that most closely matches these metrics. This representative task simplifies the analysis process by allowing the system to focus on a single, exemplary task rather than having to analyze every task in the cluster. In cases where a phase has only one occurrence, the clusters will naturally be based on that single instance. However, in phases with multiple occurrences, the clustering process may group tasks across different instances of the phase. For example, in a phase that occurs multiple times, the representative task may correspond to a specific instance of the phase that best represents the typical behavior observed across all occurrences. This approach enables efficient and focused performance analysis, targeting the most relevant tasks for optimization.

In some examples, the processing circuitry 230 is further configured to analyze the determined representative execution task for each of the determined clusters with regards to the one or more execution-performance metrics during a second execution of the application In the second execution of the application, more detailed workload data is captured, allowing the processing circuitry 230 to determine specific runtime performance metrics for specific instances of some execution phases. That is the second execution uses the insights from the first run to focus on key areas and capture more comprehensive data. For example, one or some or all of the one or more execution performance metrics described above may be used, that is: resource utilization, communication overhead, critical computational tasks, I/O intensity, thread utilization, number or names of GPU or CPU or driver function calls, hardware events and call stack behavior.

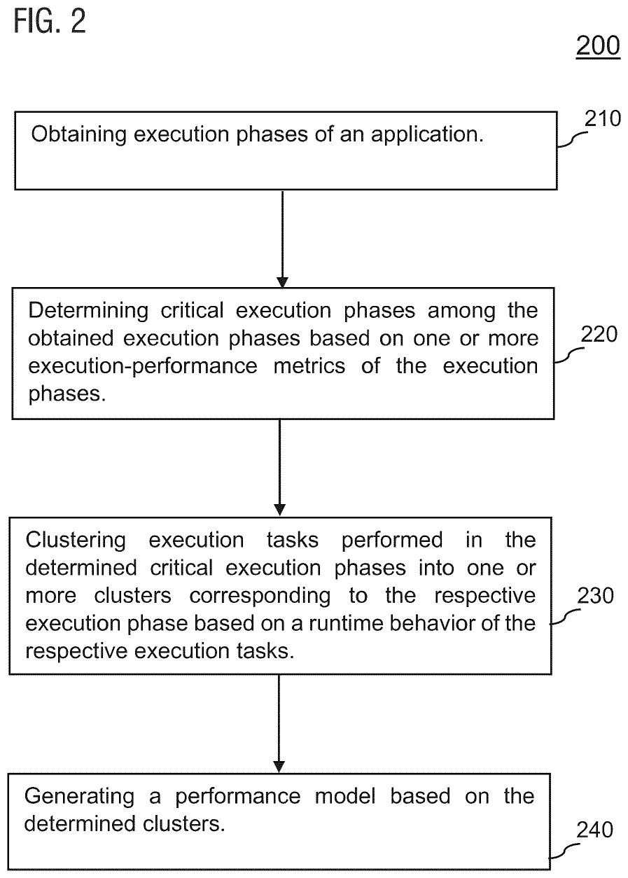

Further details and aspects are mentioned in connection with the examples described below. The example shown in FIG. 1 may include one or more optional additional features corresponding to one or more aspects mentioned in connection with the proposed concept or one or more examples described below (e.g., FIGS. 2-12).

FIG. 2 illustrates a flowchart of an example of a method 200. The method 200 may, for instance, be performed by an apparatus as described herein, such as apparatus 100. The method 200 comprises obtaining 210 execution phases of an application, the execution phases being designated during a first execution of the application, the execution of the application comprising a plurality of parallel-executing processes distributed across a plurality of nodes. The execution phases are determined based on communication events among at least a part of the plurality of processes. The method may further comprise determining 220 critical execution phases among the obtained execution phases based on one or more execution-performance metrics of the execution phases. The method may further comprise clustering 230 execution tasks performed in the determined critical execution phases into one or more clusters corresponding to the respective execution phase based on a runtime behavior of the respective execution tasks. The method may further comprise generating 240 a performance model based on the determined clusters.

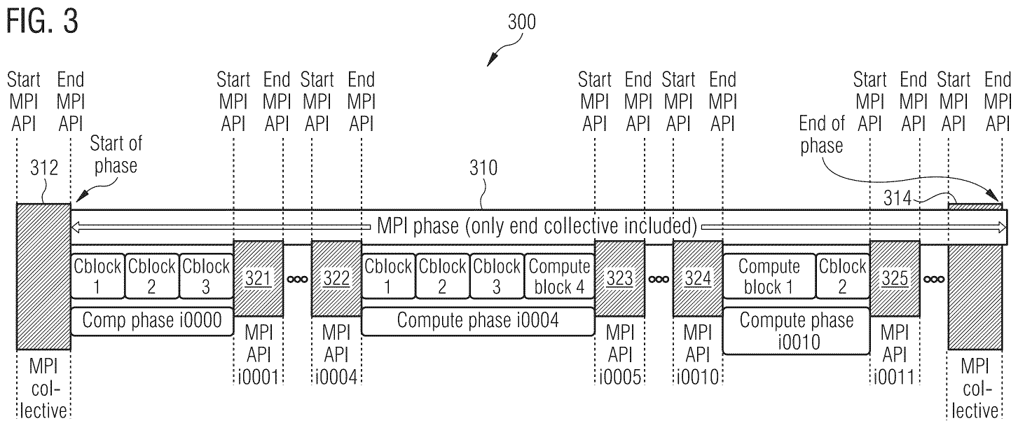

More details and aspects of the method 200 are explained in connection with the proposed technique or one or more examples described above (e.g., with reference to FIG. 1), or below. The method 200 may comprise one or more additional optional features corresponding to one or more aspects of the proposed technique, or one or more examples described above (e.g., FIG. 1) or below (e.g., FIGS. 3-12).

### FURTHER EXAMPLES

In some examples, the proposed technique enables to do performance analysis and proposes therefore using a particular definition of MPI phases in combination with various dynamic application behaviors to construct the application performance model and then uses this performance model to target performance analysis and optimizations.

FIG. 3 illustrates an MPI (Message Passing Interface) phase 300 of an HPC application that utilizes MPI. A MPI phase 310 is defined by a unique pair of MPI collectives 312, 314 (communication calls that involve all or a group of processes) to determine the start and end of the MPI phase 310. The first MPI collective 314 defines the start of the MPI phase 310 and a second MPI collective 314 defines the end of the MPI phase 310. The MPI phase 310 starts at the end of the first MPI collective 312. The MPI phase 310 ends at the end of the second MPI collective 314. For example, the described technique utilizes the call stack per MPI collective and the type of collective as part of the MPI phase definition to limit the number of MPI phases and to capture the number of times this MPI phase repeats. During an MPI phase 310 MPI API functions 321, 322, 323, 324, 325 which are not MPI collectives used to define the MPI phase 310, may be called.

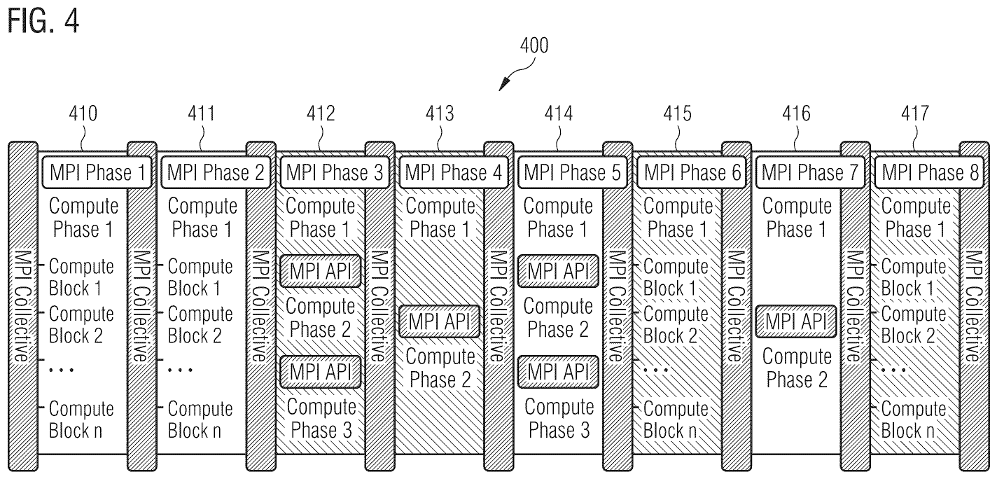

Further details and aspects are mentioned in connection with the examples described above or below. The example shown in FIG. 3 may include one or more optional additional features corresponding to one or more aspects mentioned in connection with the proposed concept or one or more examples described above (e.g., FIGS. 1-2) or below (e.g., FIGS. 4-12).

FIG. 4 illustrates an HPC application 400 broken up into MPI phases. The application 400 comprises eight MPI phases 411-418. Each of the MPI phases 411-418 is defined as starting and ending with a MPI collective as described above, for example with respect to FIG. 3 The MPI phases 412, 413, 415 may signify important phases, for example, the cumulative amount of time spent in these phases may be greater than a pre-predetermined threshold.

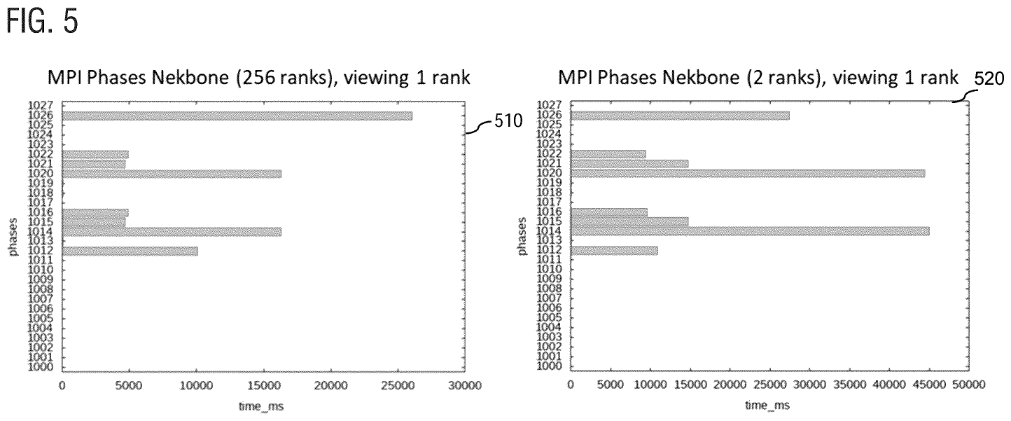

Further details and aspects are mentioned in connection with the examples described above or below. The example shown in FIG. 4 may include one or more optional additional features corresponding to one or more aspects mentioned in connection with the proposed concept or one or more examples described above (e.g., FIGS. 1-3) or below (e.g., FIGS. 5-12).

FIG. 5 illustrates a first measurement 510 and a second measurement 520 of runtimes of MPI phases of an HPC application. The first measurement 510 (left diagram in FIG. 5) shows a runtime length in milliseconds (ms) of 27 MPI phases (1000 to 1027, the graph starts numbering MPI phases at 1000) of an HPC application. The HPC application (Nekbone) of the first measurement 510 was run with 256 ranks. The first measurement 510 shows that the MPI phases 1012, 1014, 1015, 1016, 1020, 1021, 1022, 1026 have a runtime that is significant. The second measurement 520 (right diagram in FIG. 5) shows a runtime length in milliseconds (ms) of 27 MPI phases (1000 to 1027, the graph starts numbering MPI phases at 1000) of an HPC application. The HPC application (Nekbone) of the second measurement 520 is the same as the HPC application of the first measurement 510, however it was run with 2 ranks instead of 256 ranks. The second measurement 510 shows that the MPI phases 1012, 1014, 1015, 1016, 1020, 1021, 1022, 1026 have a runtime that is significant. The first measurement 510 and the second measurement 520 of the HPC application, run with a different number of ranks, comprises the same number of MPI phases and also the same significant MPI phases with regards to the runtime length. That is, the first measurement 510 and the second measurement 520 show the same number of MPI phases and similar behavior even though the runs used different number of ranks and different number of nodes. This shows that the definition of the MPI phases as described above describes an application regardless of the number of MPI ranks or the number of nodes. This definition of phases also scales with other system or application runtime changes, e.g. different number of software threads.

Further details and aspects are mentioned in connection with the examples described above or below. The example shown in FIG. 5 may include one or more optional additional features corresponding to one or more aspects mentioned in connection with the proposed concept or one or more examples described above (e.g., FIGS. 1-4) or below (e.g., FIGS. 6-12).

The MPI phases may be further subdivided or clustered by runtime behavior such as duration, instructions retired, specific hardware events, etc. as illustrated in FIG. 6.

FIG. 6 illustrates the clustering of three MPI phases based in runtime behavior. Diagram 610 shows the clustering of execution phases of the MPI phase 1020 of the first measurement 510 of MPI phases of the HPC application (Nekbone, run with 256 ranks). The execution tasks of the MPI phase 1020 may be clustered by the duration of the execution task. The MPI phase 1020 is clustered into two clusters: Cluster 1 has a smaller runtime duration of 48.8036 ms. Cluster 1 comprises 1 task that has an occurrence of 100 (i.e., frequency of the execution task). For example, cluster 1 is when a 9×9×9 matrix is solved. Cluster 2 has a longer runtime duration between 110.756 ms-115.522 ms. Cluster 2 comprises 2 execution task, which have a combined occurrence of 100. For example, cluster 2 is when a 12×12×12 matrix is solved. Diagram 620 shows the clustering of execution phases of the MPI phase 1021 of the first measurement 510 of MPI phases of the HPC application (Nekbone, run with 256 ranks). The execution tasks of the MPI phase 1021 may be clustered by the duration of the execution task. The MPI phase 1021 is clustered into two clusters: Cluster 1 has a smaller runtime duration between 13.9546-15.3809 ms. Cluster 1 comprises two execution task, which have a combined occurrence of 100 (i.e., frequency of the execution tasks). For example, cluster 1 is when a 9×9×9 matrix is solved. Cluster 2 has a longer runtime duration of 33.9227 ms. Cluster 2 comprises one execution task that has an occurrence of 100. For example, cluster 2 is when a 12×12×12 matrix is solved. Diagram 630 shows the clustering of execution phases of the MPI phase 1022 of the first measurement 510 of MPI phases of the HPC application (Nekbone, run with 256 ranks). The execution tasks of the MPI phase 1022 may be clustered by the duration of the execution task. The MPI phase 1022 is clustered into two clusters: Cluster 1 has a smaller runtime duration of 15.7772 ms. Cluster 1 comprises 1 task that has an occurrence of 99 (i.e., frequency of the execution task). For example, cluster 1 is when a 9×9×9 matrix is solved. Cluster 2 has a longer runtime duration between 33.4176 ms-34.7746 ms. Cluster 2 comprises 2 execution task, which have a combined occurrence of 99. For example, cluster 2 is when a 12×12×12 matrix is solved.

Each of the clusters of the MPI phases 1020, 2021, 1022 are made up of multiple execution tasks such as functions and/or loops. The same functions and/or loops may be used for each cluster 1 and each cluster 2 of the MPI phases 1020, 2021, 1022. However, the problem size being operated on is different, which affects duration. If for example, the application was only divided based on functions and/or loops, it may not be possible to distinguish between iterations of the different problem sizes. Dividing the application into these clusters rather than just the functions and/or loops therefore provides new insights for analysis. In another example the MPI phases 1020, 1021, 1022 may be clustered by other runtime behaviors such as instructions retired, specific hardware events, etc.

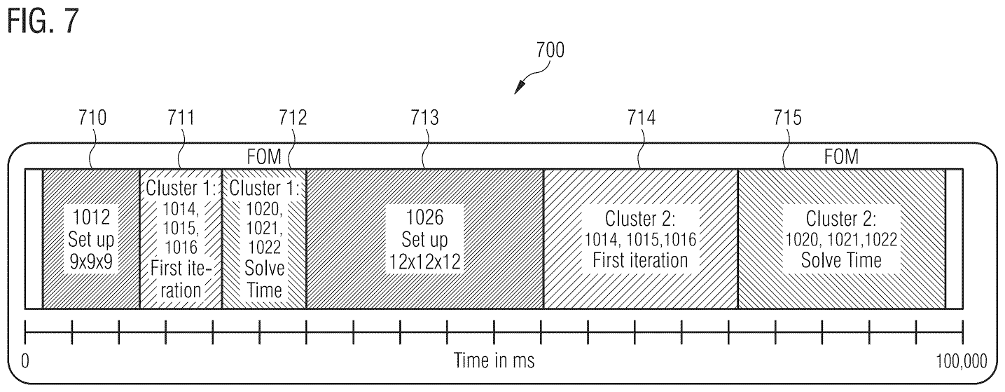

Further details and aspects are mentioned in connection with the examples described above or below. The example shown in FIG. 6 may include one or more optional additional features corresponding to one or more aspects mentioned in connection with the proposed concept or one or more examples described above (e.g., FIGS. 1-5) or below (e.g., FIGS. 7-12).

Furthermore, the timeline of the MPI phases and clusters as described above may be used to describe and analyze the behavior of the application in a novel way.

FIG. 7 illustrates a figure of merit (FOM) of the HPC application (Nekbone, run with 256 ranks, see 510 in FIG. 5) comprising a plurality of MPI phases. That is FIG. 7 shows how the HPC application's FOM is described via a combination of clusters from the MPI phases. Cluster 1 and cluster 2 of the three MPI phases of FIG. 6 are used in the timeline. The FOM 700 summarizes what is important especially with respect to the FOM and filters out what is not important. The FOM 700 comprises the MPI phase 1012 (set up of the 9×9×9 matrix) 710; the clusters 1 of the MPI phases 1014, 1015, 1016 (first iteration of the 9×9×9 matrix solve) 711; the clusters 1 of the MPI phases 1020, 1021, 1022 (solving of the 9×9×9 matrix solve) 712; the MPI phase 1026 (set up of the 12×12×12 matrix) 713; the clusters 2 of the MPI phases 1014, 1015, 1016 (first iteration of the 12×12×12 matrix solve) 714; the clusters 2 of the MPI phases 1020, 1021, 1022 (solving of the 12×12×12 matrix solve) 715. The FOM timeline view 700 illustrates the duration of each of the MPI phases. The FOM timeline view 700 illustrate the regions 712 and 715 that contribute to the FOM are disjointed and are the regions that matter most for reported performance. Though the functions 711 and 714 (labeled first iteration) may be the same as the functions 712, 715 region (labeled solve time), only the work done in the regions 712, 716 contributes most to the FOM regardless of the functions used. Thereby, the provided technique focuses on the work done via the MPI phases/clusters rather than the functions and/or loops and uses the MPI phases/clusters to generate the application performance model as below.

The application performance model in general may be determined as follows:

$$App Model = \sum ( significant clusters \cdot occurence )$$

The application performance model for the HPC application (for example Nekbone, run with 256 ranks, see 510 in FIG. 5) may be determined as follows:

$$App Model = ( 102 {0}_{1} \cdot 100 + 102 {1}_{1} \cdot 100 + 102 {2}_{1} \cdot 99 ) + ( 102 {0}_{2} \cdot 100 + 102 {1}_{2} \cdot 100 + 102 {2}_{2} \cdot 99 ) ,$$

wherein subscript 1/2 refer to cluster 1/2 of the respective MPI phase.

The generated application performance model may be evolved to describe the application regardless of the number of ranks, threads, nodes, or system used since the phase behavior remains the same. This technique may enable novel ways to do scaling analysis (e.g., n ranks vs. m ranks, similarly for threading analysis, vectorization analysis etc.) or competitive analysis (e.g., x86 system A vs. x86 system B, even systems that use different binaries but have same/similar source). The described technique may work for CPU-only, CPU+GPU, as well as primarily GPU based HPC applications.

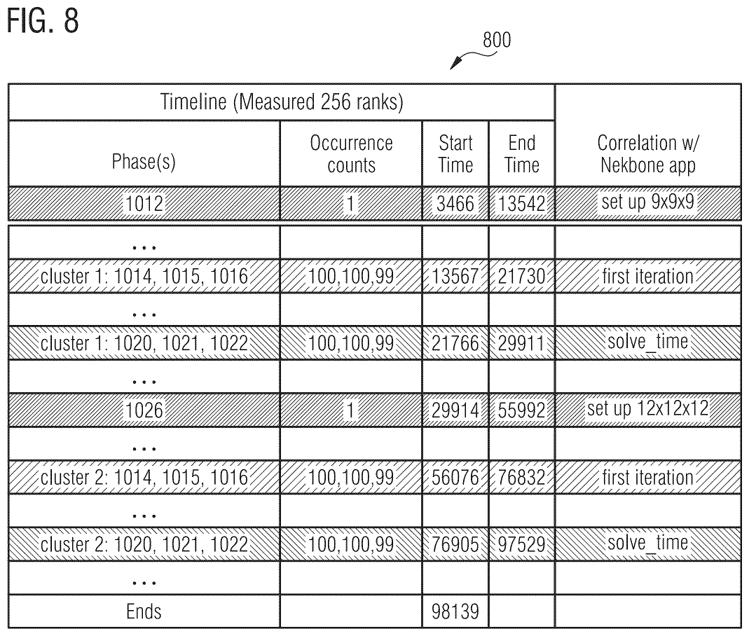

FIG. 8 illustrates a tabular view of the FOM of FIG. 7. This is including the occurrence count and start and end time of the regions that include the set of clusters from the MPI phases The FOM of the of the HPC application (Nekbone, run with 256 ranks, see 510 in FIG. 5) comprising a plurality of MPI phases a tabular view 800. The FOM in the tabular view 800 illustrates the same MPI phases as illustrated in FIG. 7 in a tabular view. The FOM in the tabular view 800 comprises in a first column the MPI phases, in a second column the occurrences of the execution tasks in the respective MPI phase, in a third column the starting time of a respective MPI phase, in a fourth column the ending time of a respective MPI phase, and in a fifth column the task that is executed (i.e., the correlation with HPC application Nekbone).

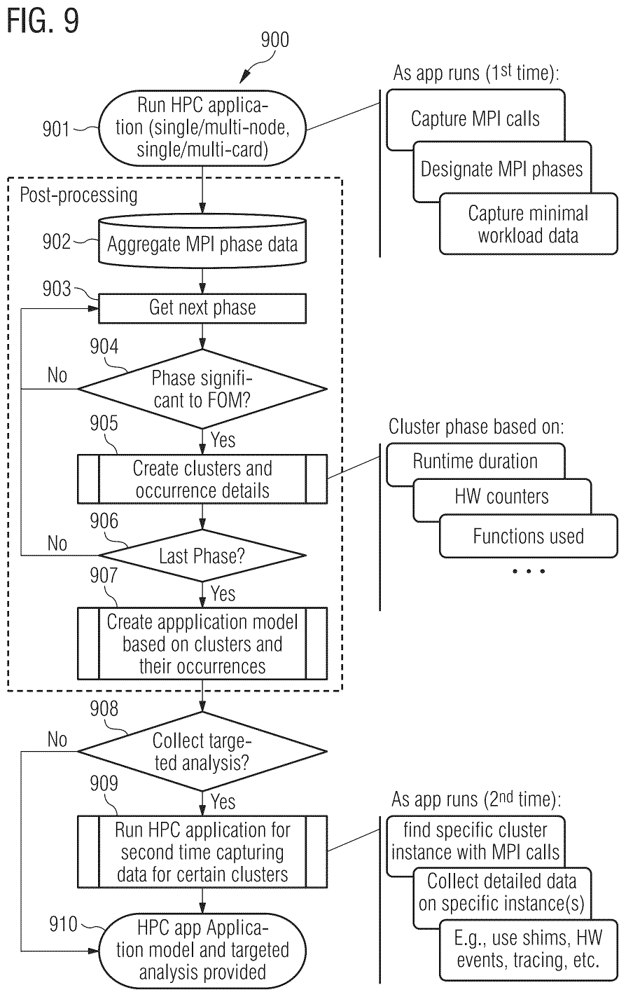

Further details and aspects are mentioned in connection with the examples described above or below. The example shown in FIGS. 7,8 may include one or more optional additional features corresponding to one or more aspects mentioned in connection with the proposed concept or one or more examples described above (e.g., FIGS. 1-6) or below (e.g., FIGS. 9-12).

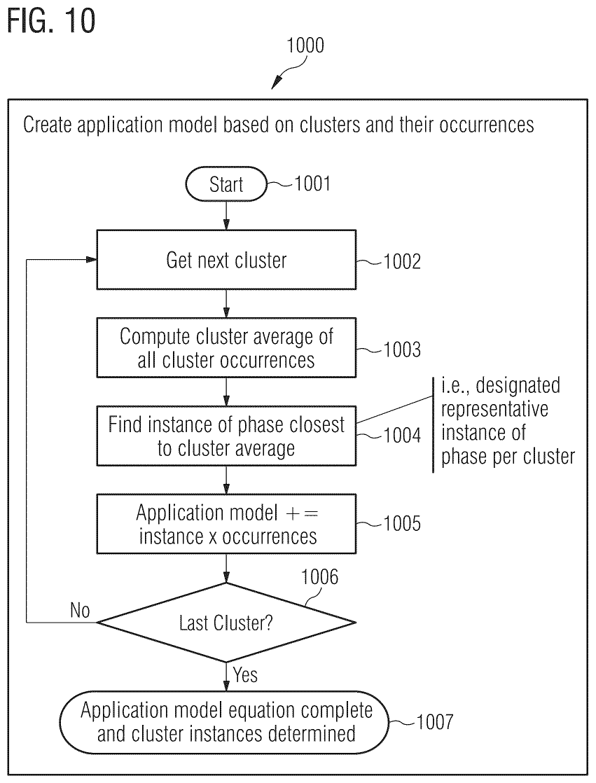

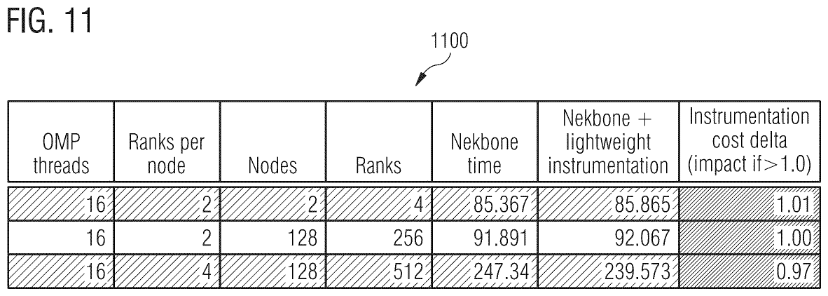

FIG. 9 illustrates flowchart 900 of an example of a method to generate the application performance model. In step 901 the HPC application is run a first run (for example with single/multi-nodes and/or single/multi-cards). During the first run the MPI calls (for example, the MPI collectives) are captured and based on this the MPI phases are designated. Further, minimal workload data is captured. In other words, lightweight data is collected during the first run of the HPC application. This lightweight data collection is specifically designed to minimize or eliminate the performance impact to the application (see FIG. 11 below). Then the post-processing (steps 902-907 starts) to generate the application performance model based on the collected lightweight data. In step 902 the collected MPI phase data are aggregated. In step 903 a next phase of the aggregated MPI phase data is picked to be analyzed in the following. In step 904 it is asked if the currently picked MPI phase is significant to the FOM. If the answer in step 904 is yes, then it is proceeded with the step 905. If the answer in step 904 is no, then it is proceeded with the step 903 and the next MPI phase is picked. In step 905 clusters and occurrence details of the currently picked MPI phase are created. The clusters are based on runtime behavior, such as runtime duration, hardware counters, functions used etc. In step 906 it is asked of the currently picked MPI phase is the last MPI phase of the HPC application from the aggregated MPI phase data. If the answer in step 906 is yes, then it is proceeded with the step 907. If the answer in step 906 is no, then it is proceeded with the step 903 and the next MPI phase is picked. In step 907 the application performance model is generated (see also FIG. 10) based on the determined clusters and their respective occurrences as described above.

In some examples, the generated application performance model may be used to collect targeted performance analysis data. In step 908 it is asked if targeted performance analysis data should be collected with the generated application performance model. If the answer in step 908 is yes, then it is proceeded with the step 909. If the answer in step 909 is no, then it is proceeded with the step 910. In step 909 a second run of the HPC application may be performed while targeted data analysis is performed. For example, the targeted data analysis may comprise threading analysis, hardware event-based analysis, detailed call stack analysis, etc. The second run and the targeted data analysis is optional second after creating the application performance model. The targeted profiling may be done on the determined representative instance of each MPI phase per cluster in the model. The targeted profiling may be done through the same MPI API function interposition methodology used by the first run but looking for a specific instance (this instance may be described as a pair of collectives on rank i with starting occurrence count j and ending occurrence count k).

For more complex HPC applications, which include applications that take hours or days to run, collecting detailed performance data for the entire run may unreasonable, expensive, and may fail or impact performance. The described technique may enable targeted analysis only for the MPI phases and clusters of importance and provide a novel way to summarize application performance. It also enables comparison between different application runs (different systems, optimizations, threads, ranks, nodes, etc.).

FIG. 10 illustrates a flowchart 1000 of an example of a method to generate the application performance model based on the determined clusters from the MPI phases. In step 1001 the method is started. In step 1002 a next cluster is picked from the determined clusters of a specific MPI phase. In step 1003 the average of all cluster occurrences is computed. In step 1004 a designated representative instance per cluster is determined. The designated representative instance is determined as that instance which is closest to the determined average of all cluster occurrences. In step 1005 it a new entry (summand) is added to the application performance model, that is the determined representative instance x the occurrences. In step 1006 it is asked of the currently picked cluster of the MPI phase is the last cluster of the specific MPI phase. If the answer in step 1006 is yes, then it is proceeded with the step 1007. If the answer in step 1006 is no, then it is proceeded with the step 1002 and the cluster of the MPI phase is picked. In step 1007 the updated application performance model is output.

Further details and aspects are mentioned in connection with the examples described above or below. The example shown in FIGS. 9, 10 may include one or more optional additional features corresponding to one or more aspects mentioned in connection with the proposed concept or one or more examples described above (e.g., FIGS. 1-8) or below (e.g., FIGS. 11-12).

FIG. 11 illustrates a table 1100 showing a performance impact of applying the lightweight data acquisition to generate the application performance model. The table 1100 comprises three rows. Each row corresponds to a different configurations of running an HPC application (Nekbone) and the corresponding performance impact of applying the lightweight data acquisition (referred to instrumentation) to generate the application performance model. The first configuration uses 16 OMP threads, 2 ranks per node, across 2 nodes (resulting in 4 total ranks), showing an Nekbone execution time of 85.367 ms without instrumentation and 85.865 ms with lightweight instrumentation, resulting in an instrumentation cost delta of 1.01, indicating a very slight increase in runtime. The second configuration utilizes 16 OMP threads, 2 ranks per node, across 128 nodes (256 total ranks), with an execution time of 91.891 ms without instrumentation and 92.067 ms with it, yielding a cost delta of 1.00, indicating no significant impact. The third configuration employs 16 OMP threads, 4 ranks per node, across 128 nodes (512 total ranks), where the execution time is 247.34 ms without instrumentation and 239.573 ms with instrumentation, resulting in an instrumentation cost delta of 0.97, indicating a slight decrease in execution time.”

In other words, the three described configurations demonstrate a minimal performance impact, which is within the application's run-to-run variability. That is the above described lightweight data collection is specifically designed to minimize or eliminate the performance impact to the application.

FIG. 12 illustrates a table 1200 showing possible performance optimizations based on generated application performance model. Table 1200 shows 4 different projections of performance optimization of an application based on an analysis of the generated application performance model. The application is performed and analyzed with the generated application performance model across four different hardware platforms. The first platform 1210 (Baseline Arch/System), shows a current performance (see left bar of 1210) around 1600 GFLOPS. No further speedup after optimization may be achieved (see right bar of 1210). The second platform 1220 (Arch/System 1) shows a current performance of around 300 GFLOPS (see left bar of 1220). The application performance model determined different potential optimizations (such as an analyzed the Symmetric Gauss-Seidel (SYMGS) kernel as the key kernel to optimize or the like). Including these optimizations may yield a 5.8× performance boost (see right bar of 1220). The third platform 1230 (Arch/System 2) shows a current performance of approximately 300 GFLOPS (see left bar of 1230), with the potential for a 5.8× performance improvement after including the potential optimizations (see right bar of 1230). The fourth platform 1240 (Arch/System 3) shows a current performance of around 300 GFLOPS (see left bar of 1240), with an estimated 5.4× speedup possible by including the potential optimizations (see right bar of 1240).

This may also be applied for performance analysis and pathfinding for other HPC applications that scale to multiple nodes and use both CPU and GPU: Nekbone, GROMACS, LAMMPS and HPCG. For example, for GROMACS, the targeted analysis enabled by the described technique may result in a hardware feature that improved the performance of the targeted region (that repeats to constitute 43% of the E2E application) by 1.6×.

Further details and aspects are mentioned in connection with the examples described above. The example shown in FIG. 12 may include one or more optional additional features corresponding to one or more aspects mentioned in connection with the proposed concept or one or more examples described above (e.g., FIGS. 1-12).

In the following, some examples of the proposed concept are presented:

An example (e.g., example 1) relates to an apparatus comprising interface circuitry, machine-readable instructions and processing circuitry to execute the machine-readable instructions to obtain execution phases of an application, the execution phases being designated during a first execution of the application, the execution of the application comprising a plurality of parallel-executing processes on a single node or distributed across a plurality of nodes, wherein the execution phases are determined based on communication events among at least a part of the plurality of processes, determine critical execution phases among the obtained execution phases based on one or more execution-performance metrics of the execution phases, cluster execution tasks performed in the determined critical execution phases into one or more clusters corresponding to the respective execution phase based on a runtime behavior of the respective execution tasks, generate a performance model based on the determined clusters.

Another example (e.g., example 2) relates to a previous example (e.g., example 1) or to any other example, further comprising that the processing circuitry is further to execute the machine-readable instructions to analyze an execution of the application based on the generated performance model.

Another example (e.g., example 3) relates to a previous example (e.g., one of the examples 1 to 2) or to any other example, further comprising that the processing circuitry is further to execute the machine-readable instructions to optimize an execution of the application based on the generated performance model.

Another example (e.g., example 4) relates to a previous example (e.g., one of the examples 1 to 3) or to any other example, further comprising that the clustering is performed by a clustering algorithm into a number of cluster for each of the critical execution phases.

Another example (e.g., example 5) relates to a previous example (e.g., one of the examples 1 to 4) or to any other example, further comprising that the processing circuitry is further to execute the machine-readable instructions to determine a cluster average for each of the determined clusters with regards to the runtime behavior used for clustering.

Another example (e.g., example 6) relates to a previous example (e.g., example 5) or to any other example, further comprising that the processing circuitry is further to execute the machine-readable instructions to determine a representative execution task for each of the determined clusters, wherein the representative execution task is the respective execution task that is closest to the respective determined cluster average.

Another example (e.g., example 7) relates to a previous example (e.g., example 6) or to any other example, further comprising that the processing circuitry is further to execute the machine-readable instructions to generate the performance model based on the determined representative execution task for each of the determined clusters and the corresponding number of times execution task of the respective cluster executed.

Another example (e.g., example 8) relates to a previous example (e.g., example 7) or to any other example, further comprising that the processing circuitry is further to execute the machine-readable instructions to analyze the determined representative execution task for each of the determined clusters with regards to the one or more execution-performance metrics during a second execution of the application.

Another example (e.g., example 9) relates to a previous example (e.g., one of the examples 1 to 8) or to any other example, further comprising that the one or more execution performance metrics comprise at least one of the following resource utilization, communication overhead, critical computational tasks, I/O intensity, thread utilization, number or names of GPU or CPU or driver function calls, hardware events and call stack behavior.

Another example (e.g., example 10) relates to a previous example (e.g., one of the examples 1 to 9) or to any other example, further comprising that the processing circuitry is further to execute the machine-readable instructions to capture workload and/or application data during the execution phases of the first and/or second execution of the application and determine the runtime behavior of the respective execution tasks based on the captured workload data.

Another example (e.g., example 11) relates to a previous example (e.g., one of the examples 1 to 10) or to any other example, further comprising that the runtime behavior of a respective execution task comprises at least one of a duration of the respective execution task, retired instructions of the respective execution task, hardware events of the respective execution task.

Another example (e.g., example 12) relates to a previous example (e.g., one of the examples 1 to 11) or to any other example, further comprising that an execution phase is starting at end of a first communication event and is ending at the end of the consecutive communication event.

Another example (e.g., example 13) relates to a previous example (e.g., one of the examples 1 to 12) or to any other example, further comprising that the execution phases are determined based on Messaging Passing Interface, MPI, communication events among the plurality of processes.

Another example (e.g., example 14) relates to a previous example (e.g., one of the examples 1 to 13) or to any other example, further comprising that an execution phase is starting at end of a Messaging Passing Interface, MPI, collective communication event and is ending at the end of the consecutive MPI collective communication event.

Another example (e.g., example 15) relates to a previous example (e.g., one of the examples 1 to 14) or to any other example, further comprising that the execution phases are determined based on two consecutive Messaging Passing Interface, MPI, communication events among the plurality of processes.

Another example (e.g., example 16) relates to a previous example (e.g., one of the examples 1 to 15) or to any other example, further comprising that the MPI collective communication event is at least one of the following broadcasting, reducing, all-reducing, synchronizing, and gathering.

An example (e.g., example 17) relates to a method comprising obtaining execution phases of an application, the execution phases being designated during a first execution of the application, the execution of the application comprising a plurality of parallel-executing processes distributed on a single node or across a plurality of nodes, wherein the execution phases are determined based on communication events among at least a part of the plurality of processes, determining critical execution phases among the obtained execution phases based on one or more execution-performance metrics of the execution phases, clustering execution tasks performed in the determined critical execution phases into one or more clusters corresponding to the respective execution phase based on a runtime behavior of the respective execution tasks, generating a performance model based on the determined clusters

Another example (e.g., example 18) relates to a previous example (e.g., example 17) or to any other example, further comprising analyzing an execution of the application based on the generated performance model.

Another example (e.g., example 19) relates to a previous example (e.g., one of the examples 17 to 18) or to any other example, further comprising optimizing an execution of the application based on the generated performance model.

Another example (e.g., example 20) relates to a previous example (e.g., one of the examples 17 to 19) or to any other example, further comprising that the clustering is performed by a clustering algorithm into a number of cluster for each of the critical execution phases.

Another example (e.g., example 21) relates to a previous example (e.g., one of the examples 16 to 20) or to any other example, further comprising determining a cluster average for each of the determined clusters with regards to the runtime behavior used for clustering.

Another example (e.g., example 22) relates to a previous example (e.g., example 21) or to any other example, further comprising determining a representative execution task for each of the determined clusters, wherein the representative execution task is the respective execution task that is closest to the respective determined cluster average.

Another example (e.g., example 23) relates to a previous example (e.g., example 22) or to any other example, further comprising generating the performance model based on the determined representative execution task for each of the determined clusters and the corresponding number of execution task of the respective cluster.

Another example (e.g., example 24) relates to a previous example (e.g., example 23) or to any other example, further comprising analyzing the determined representative execution task for each of the determined clusters with regards to the one or more execution-performance metrics during a second execution of the application.

Another example (e.g., example 25) relates to a previous example (e.g., one of the examples 17 to 24) or to any other example, further comprising that the one or more execution performance metrics comprise at least one of the following resource utilization, communication overhead, critical computational tasks, I/O intensity, thread utilization, hardware events and call stack behavior.

Another example (e.g., example 26) relates to a previous example (e.g., one of the examples 17 to 25) or to any other example, further comprising capturing workload data during the execution phases of the first and/or second execution of the application and determining the runtime behavior of the respective execution tasks based on the captured workload data.

Another example (e.g., example 27) relates to a previous example (e.g., one of the examples 17 to 26) or to any other example, wherein the runtime behavior of a respective execution task comprises at least one of a duration of the respective execution task, retired instructions of the respective execution task, hardware events of the respective execution task.

Another example (e.g., example 28) relates to a previous example (e.g., one of the examples 17 to 17) or to any other example, further comprising that an execution phase is starting at end of a first communication event and is ending at the end of the consecutive communication event.

Another example (e.g., example 29) relates to a previous example (e.g., one of the examples 17 to 28) or to any other example, further comprising that the execution phases are determined based on Messaging Passing Interface, MPI, communication events among the plurality of processes.

Another example (e.g., example 30) relates to a previous example (e.g., one of the examples 17 to 29) or to any other example, further comprising that an execution phase is starting at end of a Messaging Passing Interface, MPI, collective communication event and is ending at the end of the consecutive MPI collective communication event.

Another example (e.g., example 31) relates to a previous example (e.g., one of the examples 17 to 30) or to any other example, further comprising that the execution phases are determined based on two consecutive Messaging Passing Interface, MPI, communication events among the plurality of processes.

Another example (e.g., example 32) relates to a previous example (e.g., one of the examples 17 to 31) or to any other example, further comprising that the MPI collective communication event is at least one of the following broadcasting, reducing, all-reducing, synchronizing, and gathering.

An example (e.g., example 33) relates to an apparatus comprising a processor circuitry configured to obtain execution phases of an application, the execution phases being designated during a first execution of the application, the execution of the application comprising a plurality of parallel-executing processes on a single node or distributed across a plurality of nodes, wherein the execution phases are determined based on communication events among at least a part of the plurality of processes, determine critical execution phases among the obtained execution phases based on one or more execution-performance metrics of the execution phases, cluster execution tasks performed in the determined critical execution phases into one or more clusters corresponding to the respective execution phase based on a runtime behavior of the respective execution tasks, generate a performance model based on the determined clusters.

An example (e.g., example 34) relates to a device comprising means for processing for obtaining execution phases of an application, the execution phases being designated during a first execution of the application, the execution of the application comprising a plurality of parallel-executing processes on a single node or distributed across a plurality of nodes, wherein the execution phases are determined based on communication events among at least a part of the plurality of processes, determining critical execution phases among the obtained execution phases based on one or more execution-performance metrics of the execution phases, clustering execution tasks performed in the determined critical execution phases into one or more clusters corresponding to the respective execution phase based on a runtime behavior of the respective execution tasks, generating a performance model based on the determined clusters.

Another example (e.g., example 35) relates to a non-transitory machine-readable storage medium including program code, when executed, to cause a machine to perform the method of any one examples 17 to 32.

Another example (e.g., example 36) relates to a computer program having a program code for performing the method of any one examples 17 to 32 when the computer program is executed on a computer, a processor, or a programmable hardware component.

Another example (e.g., example 37) relates to a machine-readable storage including machine readable instructions, when executed, to implement a method or realize an apparatus as claimed in any pending claim. The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising interface circuitry, machine-readable instructions and processing circuitry to execute the machine-readable instructions to:
obtain execution phases of an application, the execution phases being designated during a first execution of the application, the execution of the application comprising a plurality of parallel-executing processes on a single node or distributed across a plurality of nodes,
wherein the execution phases are determined based on communication events among at least a part of the plurality of processes;
determine critical execution phases among the obtained execution phases based on one or more execution-performance metrics of the execution phases;
cluster execution tasks performed in the determined critical execution phases into one or more clusters corresponding to the respective execution phase based on a runtime behavior of the respective execution tasks;
generate a performance model based on the determined clusters.

2. The apparatus of claim 1, wherein the processing circuitry is further to execute the machine-readable instructions to analyze an execution of the application based on the generated performance model.

3. The apparatus of claim 1, wherein the processing circuitry is further to execute the machine-readable instructions to optimize an execution of the application based on the generated performance model.

4. The apparatus of claim 1, wherein the clustering is performed by a clustering algorithm into a number of clusters for each of the critical execution phases.

5. The apparatus of claim 1, wherein the processing circuitry is further to execute the machine-readable instructions to determine a cluster average for each of the determined clusters with regards to the runtime behavior used for clustering.

6. The apparatus of claim 5, wherein the processing circuitry is further to execute the machine-readable instructions to determine a representative execution task for each of the determined clusters, wherein the representative execution task is the respective execution task that is closest to the respective determined cluster average.

7. The apparatus of claim 6, wherein the processing circuitry is further to execute the machine-readable instructions to generate the performance model based on the determined representative execution task for each of the determined clusters and the corresponding number of times execution task of the respective cluster executed.

8. The apparatus of claim 7, wherein the processing circuitry is further to execute the machine-readable instructions to analyze the determined representative execution task for each of the determined clusters with regards to the one or more execution-performance metrics during a second execution of the application.

9. The apparatus of claim 1, wherein the one or more execution performance metrics comprise at least one of the following: resource utilization, communication overhead, critical computational tasks, I/O intensity, thread utilization, number or names of GPU or CPU or driver function calls, hardware events and call stack behavior.

10. The apparatus of claim 1, wherein the processing circuitry is further to execute the machine-readable instructions to capture application data during the execution phases of the first and/or second execution of the application; and
determine the runtime behavior of the respective execution tasks based on the captured application data.

11. The apparatus of claim 1, wherein the runtime behavior of a respective execution task comprises at least one of a: duration of the respective execution task, retired instructions of the respective execution task, hardware events of the respective execution task.

12. The apparatus of claim 1, wherein an execution phase is starting at the end of a first communication event and is ending at the end of the consecutive communication event.

13. The apparatus of claim 1, wherein the execution phases are determined based on Messaging Passing Interface, MPI, communication events among the plurality of processes.

14. The apparatus of claim 1, wherein an execution phase is starting at end of a Messaging Passing Interface, MPI, collective communication event and is ending at the end of the consecutive MPI collective communication event.

15. The apparatus of claim 1, wherein the execution phases are determined based on two consecutive Messaging Passing Interface, MPI, communication events among the plurality of processes.

16. The apparatus of claim 1, wherein the MPI collective communication event is at least one of the following: broadcasting, reducing, all-reducing, synchronizing, and gathering.

17. A method comprising:
obtaining execution phases of an application, the execution phases being designated during a first execution of the application, the execution of the application comprising a plurality of parallel-executing processes on a single node or distributed across a plurality of nodes,
wherein the execution phases are determined based on communication events among at least a part of the plurality of processes;
determining critical execution phases among the obtained execution phases based on one or more execution-performance metrics of the execution phases;
clustering execution tasks performed in the determined critical execution phases into one or more clusters corresponding to the respective execution phase based on a runtime behavior of the respective execution tasks;
generating a performance model based on the determined clusters.

18. The method of claim 17, further comprising analyzing an execution of the application based on the generated performance model.

19. The method of claim 17, further comprising optimizing an execution of the application based on the generated performance model.

20. A non-transitory machine-readable storage medium including program code, when executed, to cause a machine to perform the method of claim 17.
